(19) United States
(12) Patent Application Publication
(10) Pub. No.: US 2005/0123066 A1
(43) Pub. Date: Jun. 9, 2005

(54) Adaptive pre-distortion method and apparatus for digital rf transmitters

(76) Inventor: Octavia V Sarca, Ontario (CA)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/486,998

(22) PCT Filed: Aug. 13, 2002
(86) PCT No.: PCT/CA02/01253

Related U.S. Application Data
(60) Provisional application No. 60/311,838, filed on Aug. 14, 2001.

(51) Int. Cl. H04K 1/02

(52) U.S. Cl. 375/296

(57) ABSTRACT

A method of and apparatus for adaptive pre-distortion of a digital base band signal include applying a pre-distortion to a digital base band signal and adapting the pre-distortion in dependence upon a comparison between a pre-distorted base band signal and a digital base band derived from an amplified radio frequency signal. Pre-distortion is applied to both the signal path and a feedback path used to derive the digital base band signal from the amplified radio frequency signal. In a first embodiment non-linear pre-distortion is applied to both paths. In a second embodiment non-linear and linear pre-distortion is applied to both paths. In a third embodiment an addition linear pre-distortion is applied to the feedback path.

### FIELD OF THE INVENTION

The present invention relates to apparatus and method for digital RF transmitters and is particularly concerned with adaptive pre-distortion.

### BACKGROUND OF THE INVENTION

The wireless RF transmitters are known to employ modulation techniques such as quadrature amplitude modulation (QAM), multi-code direct sequence spread spectrum (MC-DSS), orthogonal frequency division multiplex (OFDM) and orthogonal frequency division multiple access (OFDMA). Such advanced modulation techniques are used to increase the bandwidth usage, i.e. to allow transmission of more bits/s within the same bandwidth. A drawback of such modulation techniques when compared with phase shift keying (PSK) or frequency shift keying (FSK) is that the resulting RF signal has much higher peak to average power ratio (PAPR). The advanced modulation methods may often produce PAPRs higher than 12 dB as opposed to PSK or FSK that have PAPRs closer to the 3 dB corresponding to a sine wave. A larger PAPR means an even larger ratio between highest and smallest instantaneous signal powers.

When the non-linearities of the power amplifier are neglected, the performance of the communication system depends on the ratio between the average signal power and the noise power in the bandwidth. The higher the average power the better immunity to noise the system has. A real power amplifier may introduce two types of non-linear distortions:
a) Crossover non-linearities that can greatly affect the low level signals, i.e. the portions of the transmitted signal that have low instantaneous power; and
b) Saturation non-linearities that can greatly affect the high level signals, i.e. the portions of the transmitted signal that have high instantaneous power.

A perfect amplifier has a constant gain, i.e. a constant ratio between the output and the input signal levels. Non-linearity in amplifiers can be viewed as a gain that depends on the signal level. Crossover non-linearities produce a non-constant gain at low powers. Saturation produces a decreasing gain at high powers. Certain amplifier configurations and biasing techniques (e.g. class A and AAB) can be used to reduce the crossover distortions. However, saturation cannot be avoided without reducing the power.

With a real power amplifier, its saturation will limit the maximum transmitted peak power. Ideally, the average power of the signal must be reduced to allow a margin to the saturation greater than the desired PAPR. For large PAPR this results in a poor usage of the power amplifier and a poor power supply efficiency. Therefore, many practical implementations employ a lower margin than the signal PAPR.

There are two major problems associated with using a margin lower than the PAPR of the signal.
a) The signal is distorted and thus it embeds a noise-like component caused by distortions.
b) The intermodulation products resulted from nonlinear distortions cause the signal spectrum to expand. This may cause the transmitter to violate the spectral mask required by standards and/or regulatory bodies.

For a sine wave having the frequency f1, the non-linear distortions in the power amplifier will produce parasitic components called harmonics and having frequencies of the form mf1 with m integer. The RF harmonics are easily removed by the transmitter output filter since they are far away from the desired frequency f1.

However, if two frequencies are to be transmitted at the same time, say f1 and f2, then the non-linear distortions in the power amplifier will produce both harmonics and intermodulation products having the frequencies mf1+nf2 with m and n integers. Most of these intermodulation products can also be easily removed by the transmitter output filter. However, the products with |m−n|=1 have a frequency that lay within or close to the transmitter bandwidth, and thus they cannot be removed by the output filter. The products that lay within the transmitter bandwidth will cause noise-like components in the useful signal. The products that lay close to but not within the transmitter bandwidth cause the bandwidth expansion, which can be viewed on the spectrum analyzer as the so-called “shoulders”.

The baseband version of an RF signal centered at frequency f0 is the translation of the positive part of the signal spectrum by −f0. In general this operation results in a complex signal with a spectrum centered at 0 Hz.

Using the same translation, the effect of the non-linear distortions in the power amplifier, can be viewed in baseband as variable gain, dependent on the magnitude of the complex baseband signal. In other words, the distortion can be represented in baseband as y=x f(|x|²) where x is the equivalent complex baseband signal at the input of the amplifier and y is the equivalent complex baseband signal at the output of the amplifier.

It is evident that, knowing f0 we can theoretically find an inverse function g0. If there exist g0 such that g(|z|²) f(|z g(|z|²)|2)=1 for all z then, g0 can be used in baseband to compensate the distortions in the power amplifier. Indeed, if we replace x by zg(|z|²) in the baseband model of the amplifier, we get y=z. In terms of intermodulation products, the pre-distortion function g0 will add intermodulation products that will cancel each other when recombined in the distorting power amplifier f0.

However, computing g0 is not a trivial problem, requires several approximations one of the most important being measuring/evaluating the power amplifier and extracting f0.

### SUMMARY OF THE INVENTION

According the present invention The proposed pre-distortion technique was designed to allow adaptation to variations in f0 and to compensate the linear distortions introduced by the linear filters in the up-conversion chain. Due to its adaptive nature, the method provides an easy set up since it can virtually learn any amplifier.

According to an aspect of the present invention there is provided a method of adaptive pre-distortion of a digital base band signal comprising the steps of applying a pre-distortion to a digital base band signal and adapting the pre-distortion in dependence upon a comparison between a pre-distorted base band signal and a digital base band derived from an amplified radio frequency signal.

According to an aspect of the present invention there is provided apparatus for adaptive pre-distortion of a digital base band signal comprising a device for applying a pre-distortion to a digital base band signal and a device for adapting the pre-distortion in dependence upon a comparison between a pre-distorted base band signal and a digital base band derived from an amplified radio frequency signal.

### BRIEF DESCRIPTION OF THE DRAWINGS

These and other features of the invention will become more apparent from the following description in which reference is made to the appended drawings in which:

FIG. 1 illustrates in a block diagram a known RF transmitter;

FIG. 2 illustrates in a block diagram an RF transmitter with a known non-linear pre-distortion lock;

FIG. 3 illustrates in a block diagram an RF transmitter in accordance with an embodiment of the present invention;

FIG. 4 illustrates in a block diagram an RF transmitter in accordance with another embodiment of the present invention; and

FIG. 5 illustrates in a block diagram an RF transmitter in accordance with a further embodiment of the present invention.

### DETAILED DESCRIPTION OF THE PREFERRED EMBODIMENT

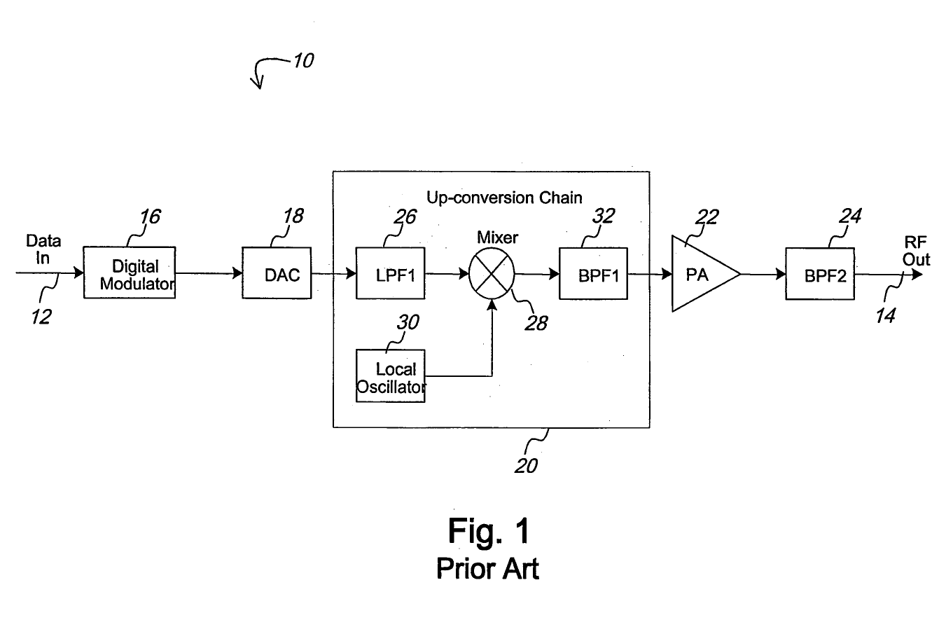

Referring to FIG. 1, there is illustrated in a block diagram a known RF transmitter. FIG. 1 illustrates a simplified block diagram of an RF transmitter 10 having a data input 12 and an RF output 14. The RF transmitter 10 includes a digital modulator 16, a digital to analog converter (DAC) 18, an up conversion chain 20, a power amplifier 22 and an output band pass filter 24 coupled between the data input 12 and the RF output 14. The up conversion chain 20 includes a low-pass filter 26, a mixer 28, a local oscillator 30 and a second band pass filter 32.

In operation, the digital modulator 16 converts input data into a digital baseband signal z. The DAC 18 converts the digital signal into an analog baseband signal. The low-pass filter (LPF1) 26 removes any unwanted images caused by the DAC 18. The local oscillator generates a sine wave at the carrier frequency that the mixer 28 uses to convert the baseband analog signal into an RF signal. The band pass filter (BPF1) 32 removes the unwanted images caused by the mixer 28. The power amplifier (PA) 22 is provided to amplify the RF signal to a desired level. Finally, the output band pass filter (BPF2) 24 is used to remove any harmonics and part of the intermodulation products produced by the PA.

When the non-linearities of the power amplifier are neglected, the performance of the communication system depends on the ratio between the average signal power and the noise power in the bandwidth. The higher the average power the better immunity to noise the system has. A real power amplifier may introduce two types of non-linear distortions:
a) Crossover non-linearities that can greatly affect the low level signals, i.e. the portions of the transmitted signal that have low instantaneous power; and
b) Saturation non-linearities that can greatly affect the high level signals, i.e. the portions of the transmitted signal that have high instantaneous power.

A perfect amplifier has a constant gain, i.e. a constant ratio between the output and the input signal levels. Non-linearity in amplifiers can be viewed as a gain that depends on the signal level. Crossover non-linearities produce a non-constant gain at low powers. Saturation produces a decreasing gain at high powers. Certain amplifier configurations and biasing techniques (e.g. class A and AAB) can be used to reduce the crossover distortions. However, saturation cannot be avoided without reducing the power.

With a real power amplifier, its saturation will limit the maximum transmitted peak power. Ideally, the average power of the signal must be reduced to allow a margin to the saturation greater than the desired PAPR. For large PAPR this results in a poor usage of the power amplifier and a poor power supply efficiency. Therefore, many practical implementations employ a lower margin than the signal PAPR.

There are two major problems associated with using a margin lower than the PAPR of the signal.
a) The signal is distorted and thus it embeds a noise-like component caused by distortions.
b) The intermodulation products resulted from nonlinear distortions cause the signal spectrum to expand. This may cause the transmitter to violate the spectral mask required by standards and/or regulatory bodies.

For a sine wave having the frequency f1, the non-linear distortions in the power amplifier will produce parasitic components called harmonics and having frequencies of the form mf1 with m integer. The RF harmonics are easily removed by the transmitter output filter since they are far away from the desired frequency f1.

However, if two frequencies are to be transmitted at the same time, say f1 and f2, then the non-linear distortions in the power amplifier will produce both harmonics and intermodulation products having the frequencies mf1+nf2 with m and n integers. Most of these intermodulation products can also be easily removed by the transmitter output filter. However, the products with |m−n|=1 have a frequency that lay within or close to the transmitter bandwidth, and thus they cannot be removed by the output filter. The products that lay within the transmitter bandwidth will cause noise-like components in the useful signal. The products that lay close to but not within the transmitter bandwidth cause the bandwidth expansion, which can be viewed on the spectrum analyzer as the so-called “shoulders”.

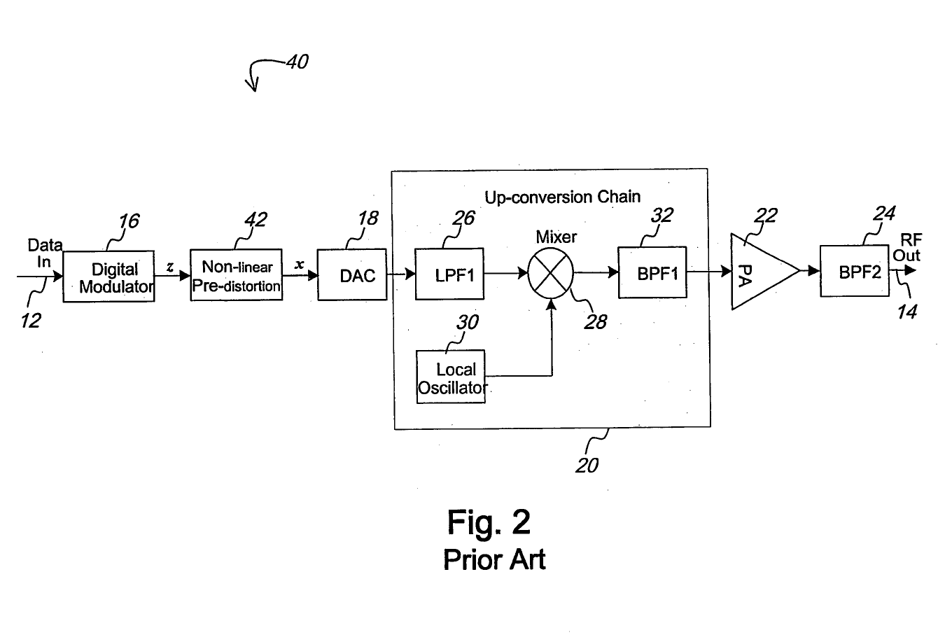

Referring to FIG. 2, there is illustrated in a block diagram an RF transmitter with a known non-linear pre-distortion block. FIG. 2 illustrates a simplified block diagram of an RF transmitter 40 having a data input 12 and an RF output 14. The RF transmitter 10 includes a digital modulator 16, a non-linear pre-distortion block 42, a digital to analog converter (DAC) 18, an up conversion chain 20, a power amplifier 22 and an output band pass filter 24 coupled between the data input 12 and the RF output 14. The up conversion chain 20 includes a low-pass filter 26, a mixer 28, a local oscillator 30 and a second band pass filter 32. The non-linear pre-distortion block 42 has been added in signal chain between the digital modulator 16 and the DAC 18 of FIG. 1.

In operation, the digital modulator 16 converts input data into a digital baseband signal z. The non-linear pre-distortion block 42 introduces a non-linear distortion into the digital baseband signal, to produce a pre-distorted baseband signal x, that is intended to cancel the affects of distortion introduced later in the transmit path by the power amplifier 22. The DAC 18 converts the pre-distorted baseband signal x into an analog baseband signal. The low-pass filter (LPF1) 26 removes any unwanted images caused by the DAC 18. The local oscillator generates a sine wave at the carrier frequency that the mixer 28 uses to convert the baseband analog signal into an RF signal. The band pass filter (BPF1) 32 removes the unwanted images caused by the mixer 28. The power amplifier (PA) 22 is provided to amplify the RF signal to a desired level. Finally, the output band pass filter (BPF2) 24 is used to remove any harmonics and part of the intermodulation products produced by the PA.

The baseband version of an RF signal centered at frequency f0 is the translation of the positive part of the signal spectrum by −f0. In general this operation results in a complex signal with a spectrum centered at 0 Hz.

Using the same translation, the effect of the non-linear distortions in the power amplifier, can be viewed in baseband as variable gain, dependent on the magnitude of the complex baseband signal. In other words, the distortion can be represented in baseband as y=x f(|x|²) where x is the equivalent complex baseband signal at the input of the amplifier and y is the equivalent complex baseband signal at the output of the amplifier.

It is evident that, knowing f0 we can theoretically find an inverse function g0. If there exists g0 such that g(|z|²) f(|z g(|z|²)|2)=1 for all z then, g0 can be used in baseband to compensate the distortions in the power amplifier. Indeed, if we replace x by zg(|z|²) in the baseband model of the amplifier, we get y=z. In terms of intermodulation products, the pre-distortion function g0 will add intermodulation products that will cancel each other when recombined in the distorting power amplifier f0.

However, computing g0 is not a trivial problem, requires several approximations one of the most important being measuring/evaluating the power amplifier and extracting f0. Note that y is not available in this implementation, and that only its RF equivalent at the output of the PA can be observed.

Pre-distortion implementations in the digital baseband have been built and they may achieve only limited improvement (3 dB to 6 dB improvement in the shoulders). There are several reasons that limit the applicability of such an approach. The characteristics of the power amplifier 22, including the saturation, change in time and with environmental conditions, for example, temperature, humidity and load. If the pre-distortion function g0 does not track the changes in the distortion function f0, the overall achievable improvement may be significantly reduced or may even have a negative affect (i.e. the pre-distortion will only decrease the overall system performance). Linear filters are typically used between the baseband-based pre-distortion and the power amplifier. Typically these include at least one anti-aliasing low-pass-filter (LPF) 26 after the digital-to-analog converter (DAC) 18 and one band pass filter 32 after the up-converting mixer 28. These linear filters can alter the signal phase and thus prevent full cancellation of the intermodulation products.

It is also known to provide a linear combiner with n inputs having a vector input X=[x₁, x₂, . . . , xₙ]^{T} and a single output o calculated as o=w₁x₁+w₂x₂+ . . . +wₙxₙ. The linear combiner is fully defined by the weight vector W=[w₁, w₂, . . . , wₙ]^{T}. Its operation can be briefly described in the matrix form as o=W^{T}X, where T denotes the matrix transpose operation.

A known result from literature is the design of the optimal linear combiner under the mean-square-error (MSE). Having a given set of pairs (X, y), where within each pair X is the input to the linear combiner and y is the desired output of the linear combiner, the MSE-optimal linear combiner is defined by the W that minimizes MSE E[(y−W^{T}X)²] where E[.] denotes the expectation operation, i.e. the average over all given pairs.

For the particular case when the linear combiner is an adaptive linear filter, i.e. the X is a vector formed by delaying the input signal with 0, 1, . . . , n-1 clocks, the optimal linear combiner is called Wiener filter.

The optimal W, according to the literature, is W=(E[XX^{T}])⁻¹ E[Xy]. The matrix E[XX^{T}] is called autocorrelation matrix of X and (E[XX^{T}])⁻¹ denotes its inverse. The vector E[Xy] is called input-output cross-correlation vector. This result is easily obtained by imposing that the gradient of MSE with respect to W is zero. Those skilled in art will recognize that this is the condition for a local minimum and that this condition results in the following equations (in order):
E[2(y−W^{T}X)X^{T}]=0
E[W^{T}XX^{T}−yX^{T}]=0
E[XX^{T}W−Xy]=0
E[XX^{T}] W=E[Xy]

If the last equation has only one solution, then that will produce the overall minimum MSE. In practical situations, if enough training pairs (X, y) are used, the equation will have a single solution.

For the linear combiner discussed above, there are several different known adaptive/iterative algorithms that update the weight vector from iteration to iteration based on a rule in the form W^{k}=W^{k-1}+c dW^{k-1} where W^{k} denotes the weight vector at iteration k and dW^{k} denotes the update vector at iteration k. One may take place every pair (X, y), or every several pairs (say M). The update vector is typically calculated accordingly over each pair or over a block of M pairs.

For example, the optimal algorithm can be changed to become adaptive by grouping data pairs (X,y) in blocks of Mpairs by estimating (E¹[XX^{T}])⁻¹ E^{k}[Xy] for every block k and by calculating the update vector as dW^{k-1}=(E^{k}[XX^{T}])⁻¹ E^{k}[Xy]−W^{k-1}. It can be shown that if data pairs (X,y) come from a stationary process and if M is enough large then W^{k} converges to the optimal W. For small c the convergence requires more iterations but smaller blocks. For large c the convergence requires less iterations but larger block sizes. For c=1 and M equal to the whole data set (one block only), then the adaptive algorithm becomes the optimal one, i.e. produces a solution in exactly one iteration.

There are many other methods that can perform the same task with less computational requirements. For example: least-mean-square (LMS) algorithm, Newton-algorithm, least-squares and recursive least-squares algorithms. Some of the methods may have limitations on the precision that can be obtained in a reasonable number of iterations, some may never reach the optimal W even with infinite M. However, these methods perform well on real data, offering reasonable precision and thus they can replace the optimal one for adaptation.

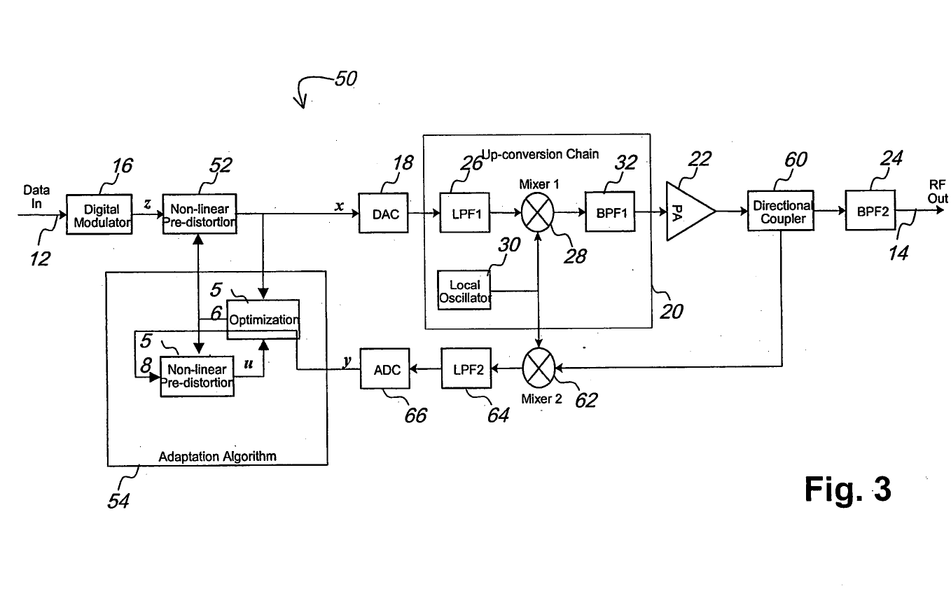

Referring to FIG. 3 there is illustrated in a block diagram an RF transmitter in accordance with an embodiment of the present invention. FIG. 3 illustrates a simplified block diagram of an RF transmitter 50 having a data input 12 and an RF output 14. The RF transmitter 50 includes a digital modulator 16, a non-linear pre-distortion block 52, an adaptation block 54 coupled to the non-linear pre-distortion block 52, a digital to analog converter (DAC) 18, an up conversion chain 20, a power amplifier 22, a directional coupler 60 and an output band pass filter 24 coupled between the data input 12 and the RF output 14. The up conversion chain 20 includes a low-pass filter 26, a mixer 28, a local oscillator 30 and a second band pass filter 32. The adaptation block 54 includes an optimization block 56 and a second non-linear pre-distortion block 58. The directional coupler 60 is connected to a second mixer 62 having an input coupled to the local oscillator 30 and an output coupled to a second low-pass filter 64 and an analog to digital converter (ADC) 66, forming a feedback path from the output of the power amplifier 22 to the adaptation block 54.

In operation, the RF transmitter of FIG. 3 employs a feedback path including the directional coupler 60, the second mixer 62, the second low-pass filter 64 and the ADC 66 to couple output from the power amplifier 22 to the adaptation block 54. The directional coupler 60 is used to extract a small part of the output signal from the power amplifier 22. The second mixer 62 is used to down convert the feedback signal from RF back to baseband. The second low pass filter 64 (LPF2) is used to avoid aliasing of unwanted components in the ADC 66. The analog to digital converter 66 converts the analog baseband signal to a digital baseband signal y, which is then passed through non-linear pre-distortion block 58 compared by the optimization block 56 to the digital baseband signal x output by the non-linear pre-distortion block 52 to determine adjustments needed to the parameters of non-linear pre-distortion block 52 and the non-linear pre-distortion block 58 in accordance with the adaptation algorithm.

The present pre-distortion technique was designed to allow adaptation to variations in f0 the distortion function of the power amplifier 22. Due to its adaptive nature, the method provides an easy set up since it can learn virtually any amplifier. According to the notations used, in the FIG. 3, the signal at the output of the digital modulator is z, at the input of the DAC is x and at the output of the ADC is y.

In order to find the distortion function f0 and its inverse g0 as defined above, one may in principle search the space of all possible functions. However, this would require an infinite amount of data to be collected. Therefore, we limit g0 to be a polynomial of finite order k: g(t)=a₀+a₁t+ . . . +aₖt^{k}. Using the notations above, the function implemented by the non-linear pre-distortion block can be written as:
x=a₀z+a₁|z|²z+ . . . aₖ|z|^{2k}z which a linear combiner x=A^{T}Z with the input vector Z=[z,|z|²z, . . . , |z|^{2k}z]^{T} and the weight vector A=[a₀, a₁, . . . , aₖ]^{T}.

In order to perform adaptation, i.e. to minimize MSE between z and y, the adaptation algorithm implements a non-linear pre-distortion block 58 applied toy, which is paired with the one in the main signal path (applied to z) and has the same coefficients. Let the output of the non-linear pre-distortion block be u. Then, with certain restrictions, minimizing MSE between z and y is equivalent to minimizing MSE between x and u. Restrictions are that weights in A shall not decrease or become all zero in the course of minimization.

Hence the present method reduces the problem of designing a non-linear pre-distortion to the problem of designing a linear combiner u=A^{T}Y with the input vector Y=[y, |y|²y, . . . , |y|^{2k}y]^{T}, the weight vector A=[a₀, a₁, . . . , aₖ]^{T} and the MSE function E[(x−A^{T}Y)²]. Any of the algorithms (optimal or adaptive) described in the prior art can be applied here.

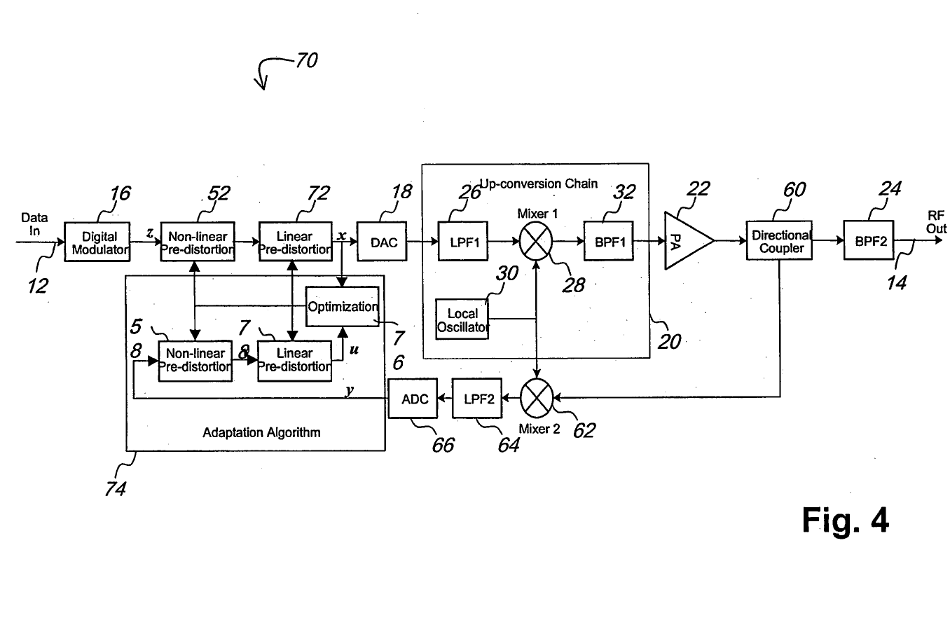

Referring to FIG. 4 there is illustrated in a block diagram an RF transmitter in accordance with another embodiment of the present invention. FIG. 4 illustrates a simplified block diagram of an RF transmitter 70 having a data input 12 and an RF output 14. The RF transmitter 70 includes a digital modulator 16, a non-linear pre-distortion block 52, a linear pre-distortion block 72, an adaptation block 74 coupled to the non-linear pre-distortion block 52 and the linear pre-distortion block 72, a digital to analog converter (DAC) 18, an up conversion chain 20, a power amplifier 22, a directional coupler 60 and an output band pass filter 24 coupled between the data input 12 and the RF output 14. The up conversion chain 20 includes a low-pass filter 26, a mixer 28, a local oscillator 30 and a second band pass filter 32. The directional coupler 60 is connected to a second mixer 62 having an input coupled to the local oscillator 30 and an output coupled to a second low-pass filter 64 and an analog to digital converter (ADC) 66, forming a feedback path from the output of the power amplifier 22 to the adaptation block 74. The adaptation block 74 includes an optimization block 76, the non-linear pre-distortion block 58, and a linear pre-distortion block.

In operation, the linear pre-distortion block 72, added after the non-linear pre-distortion, provides linear compensation for any linear distortions introduced by the linear filters (e.g., 26 and 32) in the up-conversion chain 20. The RF transmitter of FIG. 4 employs a feedback path including the directional coupler 60, the second mixer 62, the second low-pass filter 64 and the ADC 66 to couple output from the power amplifier 22 to the adaptation block 74. The directional coupler 60 is used to extract a small part of the output signal from the power amplifier 22. The second mixer 62 is used to down convert the feedback signal from RF back to baseband. The second low pass filter 64 (LPF2) is used to avoid aliasing of unwanted components in the ADC 66. The analog to digital converter converts the analog baseband signal to a digital baseband signal y, which is then compared to the digital baseband signal x output by the linear pre-distortion block 72 to determine adjustments needed to non-linear pre-distortion blocks 52 and 58 and linear pre-distortion blocks 72 and 78 in accordance with the adaptation algorithm.

According to the notations used in FIG. 4, the signal at the output of the digital modulator 16 is z, at the input of the DAC 18 is x and at the output of the ADC 66 is y. Let the output of the non-linear pre-distortion block 58 in the adaptation algorithm 74 be v and the output of the linear pre-distortion block 78 in the adaptation algorithm 74 be u. Then, with the same restrictions as in the embodiment of FIG. 3, minimizing MSE between z and y is equivalent to minimizing MSE between x and u.

Let the linear pre-distortion block be an finite-impulse-response (FIR) filter with m+1 coefficients: u(n)=b₀v(n)+b₁v(n-1)++bₘv(n-n). This can also be written as a linear combiner u(n)=B^{T}V(n) with input vector V(n)=[v(n), v(n-1), V(n-m)]^{T} and the weight vector B=[b₀, b₁, . . . ,bₘ]^{T}. Recall that the non-linear pre-distortion block also implements a linear combiner v=A^{T}Y with Y==[y, |y|²y, . . . , |y|^{2k}y]^{T} and the weight vector A=[a₀, a₁, . . . , aₖ]^{T}. Then, the non-linear and the linear pre-distortion blocks form a cascade of linear combiners. In the following, we show that these cascaded linear combiners can be designed separately using the same methods described in the previous art.

$$Let \underline{Y} ( n ) = [ Y ( n ) , Y ( n - 1 ) , … , Y ( n - m ) ] . \\ Then , {V}^{T} ( n ) = {A}^{T} \underline{Y} ( n ) and u ( n ) = {B}^{T} V ( n ) = {{B}^{T} ( {A}^{T} \underline{Y} ( n ) )}^{T}$$

$$which can be rewritten in two ways \text{:}$$

$$\begin{matrix}• & u ( n ) = {B}^{T} ( {\underline{Y}}^{T} ( n ) A ) \\ • & u ( n ) = {A}^{T} ( \underline{Y} ( n ) B )\end{matrix}$$

The first form can be used to design/adapt the combiner for linear pre-distortion, with the input vector Y^{T}(n)A, weight vector B and error function E[(x−u)²]. The second form can be used to design/adapt the combiner for non-linear pre-distortion, with the input vector Y(n)B, weight vector A and error function E[(x−u)²].

Within the preferred implementation for this method, the data is divided into indexed blocks of M pairs (Y, x) and the odd blocks are used to adapt/design the linear pre-distortion and the even blocks are used to adapt/design the non-linear pre-distortion.

It was shown that linear and non-linear distortions are orthogonal operations and thus separate compensation shall be provided for each of these. The orthogonality between the linear and non-linear distortions implies that the linear and the non-linear pre-distortion blocks can be simultaneously trained on the same data block and that there exists only one optimal solution.

The linear pre-distortion block introduced by the present method will allow a good alignment in time and phase between the non-linear pre-distortion and the power amplifier. Thus it not only improves significantly the performance of the non-linear pre-distortion but it also helps the automatic detection of the non-linear pre-distortion function g0. In other words, the time and phase alignment is the key factor that allows the use of an adaptation algorithm.

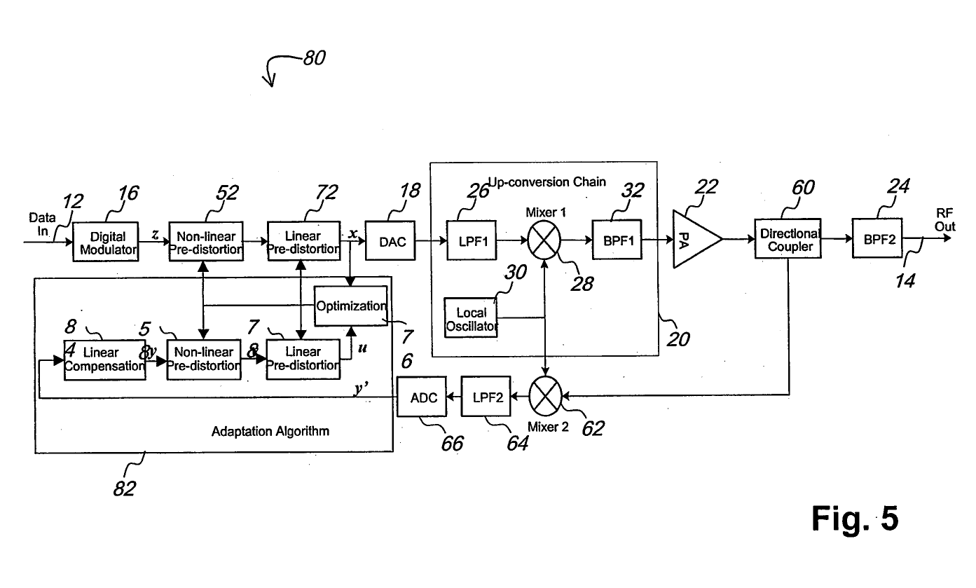

Referring to FIG. 5 there is illustrated in a block diagram an RF transmitter in accordance with a further embodiment of the present invention. FIG. 5 illustrates a simplified block diagram of an RF transmitter 80 having a data input 12 and an RF output 14. The RF transmitter 80 includes a digital modulator 16, a, non-linear pre-distortion block 52, a linear pre-distortion block 72, an adaptation block 82 coupled to the non-linear pre-distortion block 52 and the linear pre-distortion block 72, a digital to analog converter (DAC) 18, an up conversion chain 20, a power amplifier 22, a directional coupler 60 and an output band pass filter 24 coupled between the data input 12 and the RF output 14. The up conversion chain 20 includes a low-pass filter 26, a mixer 28, a local oscillator 30 and a second band pass filter 32. The directional coupler 60 is connected to a second mixer 62 having an input coupled to the local oscillator 30 and an output coupled to a second low-pass filter 64 and an analog to digital converter (ADC) 66, forming a feedback path from the output of the power amplifier 22 to the adaptation block 82. The adaptation block 82 includes an optimization block 76, the non-linear pre-distortion block 58, the non-linear pre-distortion block 78 and a linear compensation block 84. The linear compensation block 84 is coupled between the ADC 66 output and the input to the non-linear pre-distortion block 58.

In operation, the linear pre-distortion block 72, added after the non-linear pre-distortion 52, provides linear compensation for any linear distortions introduced by the linear filters (e.g., 26 and 32) in the up-conversion chain 20, while the linear compensation block 84 provides a correction for linear distortions outside the up-conversion chain 20. The RF transmitter of FIG. 5 employs a feedback path including the directional coupler 60, the second mixer 62, the second low-pass filter 64 and the ADC 66 to couple output from the power amplifier 22 to the adaptation block 82. The directional coupler 60 is used to extract a small part of the output signal from the power amplifier 22. The second mixer 62 is used to down convert the feedback signal from RF back to baseband. The second low pass filter 64 (LPF2) is used to avoid aliasing of unwanted components in the ADC 66. The analog to digital converter 66 converts the analog baseband signal to a digital baseband signal y′, which is then has linear compensation applied by block 84 to produce digital baseband signal y which is compared (after non-linear and linear pre-distortion) to the digital baseband signal x output by the linear pre-distortion block 72 to determine adjustments needed to non-linear pre-distortion blocks 52 and 58 and linear pre-distortion blocks 54 and 78 in accordance with the adaptation algorithm.

In the third embodiment an additional linear compensation block 84 is added only in the adaptation algorithm block 82. According to the notations, the output of the ADC 66 is now y′ and the output of the linear compensation block 84 is y.

It can be easily shown that linear and non-linear distortions are also non-commutative in the sense that the linear and the non-linear pre-distortion blocks cannot be switched (exchange places). One can verify that a linear combiner placed before the g0 function cannot be moved after without changing the equations and vice versa. Since linear and non-linear operations are not commutative, the linear pre-distortion after the non-linear block will compensate only the linear distortions caused by the filters in the up-converting chain and it will not compensate for filters outside of this chain like the transmitter output filter. Similarly, the linear compensation block filter will compensate the linear distortion on the down-conversion path from PA 22 to ADC 24. This facilitates even better time and phase alignment than second embodiment, which allows further improvements in the pre-distortion performance.

The design/adaptation algorithm works as in the second embodiment with the exception that from time to time a gradient descent method is used to adapt the linear compensation block. Within the preferred implementation for this method, the data is divided into blocks of M pairs (Y, x). Two or several blocks are used to adapt/design the linear and non-linear pre-distortion blocks. Then one or several blocks are used to evaluate the resulting MSE between u and x, to calculate the gradient of MSE with respect to coefficients in the compensation block and to adjust them according to the classic gradient descent method. Then the cycle repeats from the adaptation/design of the linear and non-linear pre-distortion blocks.

The present method uses an additional linear pre-distortion (compensation) block 84 placed immediately following the non-linear pre-distortion in the baseband chain. It also uses a feed back chain from the output of the power amplifier to feed data to the adaptation algorithm 82.

The additional linear pre-distortion block 84 allows almost perfect alignment in time and phase between the non-linear pre-distortion and the distortion in the power amplifier. Thus it significantly improves the performance of the pre-distortion system.

The time and phase alignment, together with the orthogonality between linear and non-linear distortions allows the development of adaptation algorithms that:
Can be used to automatically calculate the linear and non-linear pre-distortion functions
Can be used to track the changes in the power amplifier characteristics and therefore can help preserve the maximum achievable performance in time and with environment variations.
   Numerous modifications, variations and adaptations may be made to the particular embodiments of the invention described above without departing from the scope of the claims, which is defined in the claims.

1. A method of adaptive pre-distortion of a digital base band signal comprising the steps of:
a) applying a pre-distortion to a digital base band signal; and
b) adapting the pre-distortion in dependence upon a comparison between a pre-distorted base band signal and a digital base band derived from an amplified radio frequency signal.

2. A method as claimed in claim 1 wherein the step of applying a pre-distortion includes the step of applying a first pre-distortion.

3. A method as claimed in claim 2 wherein the first pre-distortion is a non-linear pre-distortion.

4. A method as claimed in claim 2 wherein the step of applying a pre-distortion includes the step of applying a second pre-distortion.

5. A method as claimed in claim 4 wherein the first pre-distortion is a non-linear pre-distortion.

6. A method as claimed in claim 4 wherein the second pre-distortion is a linear pre-distortion.

7. A method as claimed in claim 1 wherein the step of adapting includes the step of applying a pre-distortion to the digital base band signal derived from the amplified radio frequency signal.

8. A method as claimed in claim 7 wherein the pre-distortion includes a third pre-distortion.

9. A method as claimed in claim 8 wherein the third pre-distortion is a non-linear pre-distortion

10. A method as claimed in claim 7 wherein the step of applying a pre-distortion includes the step of applying a fourth pre-distortion.

11. A method as claimed in claim 10 wherein the third pre-distortion is a non-linear pre-distortion.

12. A method as claimed in claim 10 wherein the fourth pre-distortion is a linear pre-distortion.

13. A method as claimed in 11 wherein the pre-distortion is dependent upon a set of parameters.

14. A method as claimed in claim 13 wherein the set of parameters for the first and third pre-distortions are the same.

15. A method as claimed in claim 14 wherein the set of parameters for the second and fourth pre-distortions are the same.

16. Apparatus for adaptive pre-distortion of a digital base band signal comprising:
a) means for applying a pre-distortion to a digital base band signal; and
b) means for adapting the pre-distortion in dependence upon a comparison between a pre-distorted base band signal and a digital base band derived from an amplified radio frequency signal.

17. Apparatus as claimed in claim 16 wherein the means for applying a pre-distortion includes means for applying a first pre-distortion.

18. Apparatus as claimed in claim 17 wherein the first pre-distortion is a non-linear pre-distortion.

19. Apparatus as claimed in claim 17 wherein the means for applying a pre-distortion includes means for applying a second pre-distortion.

20. Apparatus as claimed in claim 19 wherein the first pre-distortion is a non-linear pre-distortion.

21. Apparatus as claimed in claim 19 wherein the second pre-distortion is a linear pre-distortion.

22. Apparatus as claimed in claim 16 wherein the means for adapting includes means for applying a pre-distortion to the digital base band signal derived from the amplified radio frequency signal.

23. Apparatus as claimed in claim 22 wherein the pre-distortion includes a third pre-distortion.

24. Apparatus as claimed in claim 23 wherein the third pre-distortion is a non-linear pre-distortion

25. Apparatus as claimed in claim 22 wherein the means for applying a pre-distortion includes means for applying a fourth pre-distortion.

26. Apparatus as claimed in claim 25 wherein the third pre-distortion is a non-linear pre-distortion.

27. Apparatus as claimed in claim 25 wherein the fourth pre-distortion is a linear pre-distortion.

28. Apparatus as claimed in 26 wherein the pre-distortion is dependent upon a set of parameters.

29. Apparatus as claimed in claim 28 wherein the set of parameters for the first and third pre-distortions are the same.

30. Apparatus as claimed in claim 29 wherein the set of parameters for the second and fourth pre-distortions are the same.
